(19) United States
(12) Patent Application Publication
(10) Pub. No.: US 2025/0233340 A1
(43) Pub. Date: Jul. 17, 2025

(54) Terminal, Electrical Connection Module and Connector

(71) Applicant: Tyco Electronics (Shanghai) Co., Ltd., Shanghai (CN)

(72) Inventors: Dingbing (Frank) Fan, Shanghai (CN); Ming Shi, Shanghai (CN); Xiaozhi (George) Fu, Shanghai (CN); Wei Zhang, Shanghai (CN); Zhao Cheng, Shanghai (CN)

(73) Assignee: Tyco Electronics (Shanghai) Co., Ltd., Shanghai (CN)

(21) Appl. No.: 19/022,503

(22) Filed: Jan. 15, 2025

(30) Foreign Application Priority Data
Jan. 15, 2024 (CN) 202420097793.2

(51) Int. Cl. H01R 13/432; H01R 4/18; H01R 13/11; H01R 13/436; H01R 13/642

(52) U.S. Cl. CPC H01R 13/432; H01R 4/185; H01R 13/11; H01R 13/4361; H01R 13/642

(57) ABSTRACT

A terminal includes a mating part having an insertion cavity extending along a longitudinal direction of the terminal and a first cantilever located in the insertion cavity. The first cantilever has a plurality of first electrical contacts spaced apart from each other in the longitudinal direction and simultaneously electrically contacting a side of a mating terminal inserted into the insertion cavity. A free end of the first cantilever is pressed against an inner wall surface of the insertion cavity. The mating part has a primary lock engaging a housing of a connector and a secondary lock feature engaging a secondary lock inserted into the housing, locking the terminal in the housing through the primary lock and the secondary lock.

### CROSS-REFERENCE TO RELATED APPLICATION

This application claims the benefit of the filing date under 35 U.S.C. § 119 (a)-(d) of Chinese Patent Application No. 202420097793.2, filed on Jan. 15, 2024.

### FIELD OF THE INVENTION

The present invention relates to a terminal, an electrical connection module comprising the terminal, and an electrical connector comprising the electrical connection module.

### BACKGROUND

The terminal of a connector usually only has a single cantilever and a single electrical contact formed on the single cantilever, which leads to unstable and unreliable electrical contact between the terminal of the connector and the terminal of the mating connector.

### SUMMARY OF THE INVENTION

A terminal includes a mating part having an insertion cavity extending along a longitudinal direction of the terminal and a first cantilever located in the insertion cavity. The first cantilever has a plurality of first electrical contacts spaced apart from each other in the longitudinal direction and simultaneously electrically contacting a side of a mating terminal inserted into the insertion cavity. A free end of the first cantilever is pressed against an inner wall surface of the insertion cavity. The mating part has a primary lock engaging a housing of a connector and a secondary lock feature engaging a secondary lock inserted into the housing, locking the terminal in the housing through the primary lock and the secondary lock.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a terminal according to a first embodiment of the present invention when viewed from the front side;

FIG. 2 shows an illustrative perspective view of the terminal according to the first embodiment of the present invention when viewed from the rear side;

FIG. 3 shows a longitudinal sectional view of the mating part of the terminal according to the first embodiment of the present invention;

FIG. 4 shows a longitudinal sectional view of the mating part of the terminal and mating terminal according to the first embodiment of the present invention;

FIG. 5 shows an illustrative perspective view of a connector according to the first embodiment of the present invention;

FIG. 6 shows a longitudinal sectional view of a connector according to the first embodiment of the present invention;

FIG. 7 shows an illustrative exploded view of the connector according to the first embodiment of the present invention;

FIG. 8 shows an illustrative perspective view of a terminal according to the second embodiment of the present invention;

FIG. 9 shows a longitudinal sectional view of the mating part of the terminal according to the second embodiment of the present invention;

FIG. 10 shows a longitudinal sectional view of the mating part of the terminal and mating terminal according to the second embodiment of the present invention;

FIG. 11 shows an illustrative perspective view of a terminal according to a third embodiment of the present invention;

FIG. 12 shows a longitudinal sectional view of the mating part of the terminal according to the third embodiment of the present invention; and

FIG. 13 shows a longitudinal sectional view of the mating part of the terminal and mating terminal according to the third embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

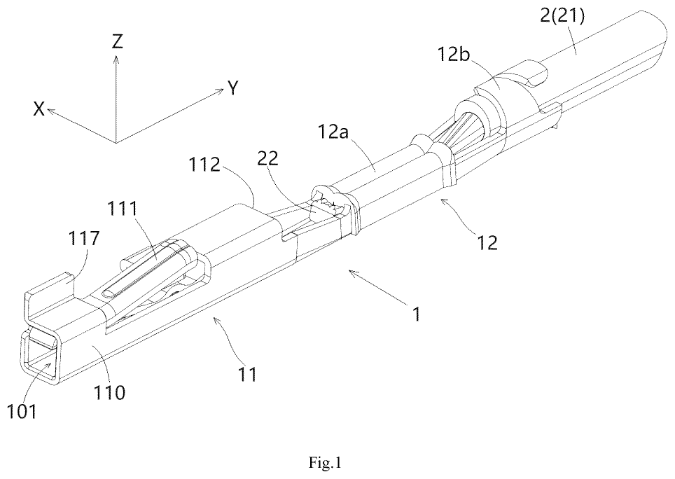

FIGS. 1 to 7 show the first embodiment according to the present invention. As shown in FIGS. 1 to 7, in an exemplary embodiment of the present invention, a terminal 1 of a connector is disclosed.

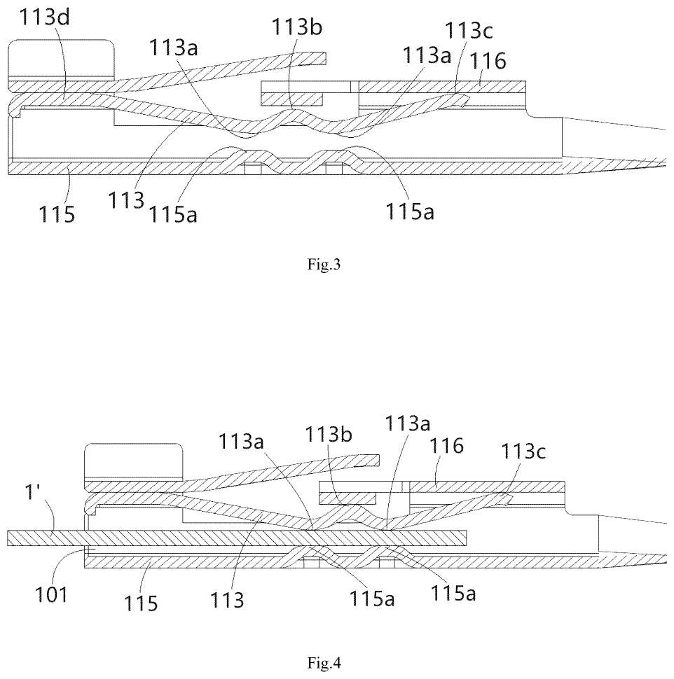

The terminal 1 includes a mating part 11 for mating with a mating terminal 1′ of a mating connector. The mating part 11 has an insertion cavity 101 extending along the longitudinal direction Y of terminal 1 and a first cantilever 113 located in the insertion cavity 101. The first cantilever 113 has multiple first electrical contacts 113a, shown in FIGS. 3 and 4, which are spaced apart from each other in the longitudinal direction Y for simultaneous electrical contact with one side of the mating terminal 1′ inserted into the insertion cavity 101. The free end 113c of the first cantilever 113 is pressed against the inner wall surface of the insertion cavity 101. This ensures stable and reliable electrical contact between the first cantilever 113 and the mating terminal 1′.

As shown in FIGS. 1, 2, and 6, in the illustrated embodiment, the mating part 11 also has a primary lock 111 adapted to engage with the housing 3 of the connector and a secondary lock feature 112 adapted to engage with a secondary lock 4 inserted into the housing 3, so as to be able to lock the terminal 1 in the housing 3 through the primary lock 111 and the secondary lock 4.

As shown in FIGS. 3 and 4, in the illustrated embodiment, the mating part 11 includes a bottom plate 115 and a top plate 116 that are opposite in the height direction Z of terminal 1, and a pair of side plates 110 that are opposite in the transverse direction X of terminal 1. The aforementioned insertion cavity 101 is surrounded by the top plate 116, the bottom plate 115, and the pair of side plates 110.

As shown in FIGS. 1 to 7, in the illustrated embodiment, the mating part 11 has front and rear ends that are opposite in the longitudinal direction Y, and the first cantilever 113 extends between the front and rear ends of the mating part 11. The fixed end 113d of the first cantilever 113 is connected to the front end of the top plate 116, and the free end 113c of the first cantilever 113 is pressed against the inner side of the rear end of the top plate 116.

As shown in FIGS. 3 and 4, in the illustrated embodiment, multiple protruding second electrical contacts 115a are formed on the inner side of the bottom plate 115, which are used to simultaneously make electrical contact with the other side of the mating terminal 1′ inserted into the aforementioned insertion cavity 101. The multiple second electrical contacts 115a correspond to multiple first electrical contacts 113a and are aligned to multiple first electrical contacts 113a in the height direction Z, respectively.

As shown in FIGS. 3 and 4, in the illustrated embodiment, the first cantilever 113 also has a support portion 113b protruding towards the top plate 116, which is located between two adjacent first electrical contacts 113a in the longitudinal direction Y. When the mating terminal 1′ is inserted into the insertion cavity 101 of the mating part 11, the support portion 113b and the free end 113c of the first cantilever 113 simultaneously press against the inner side of the top plate 116.

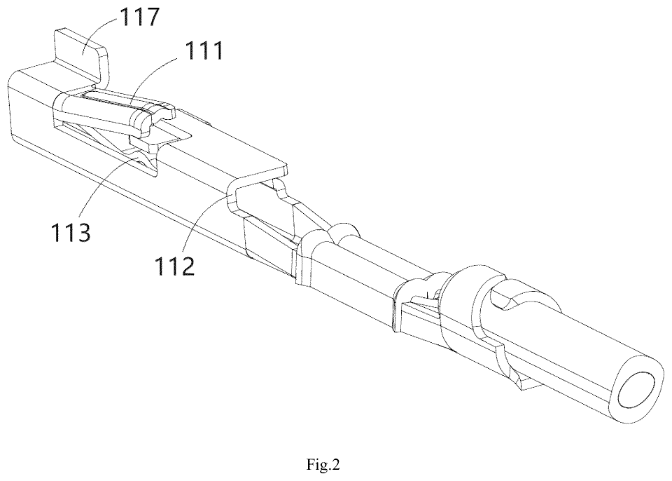

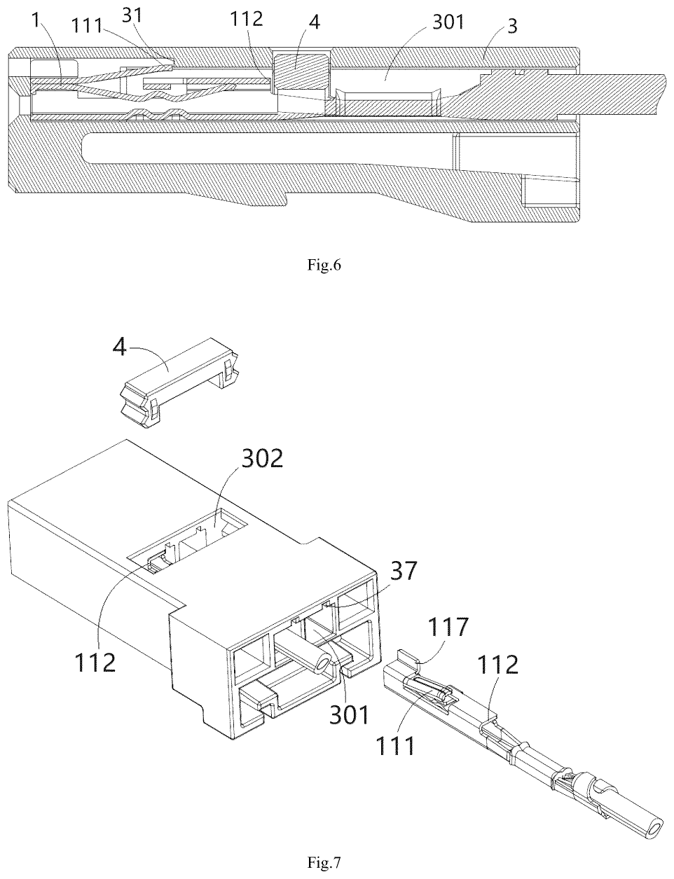

As shown in FIGS. 1 and 2, in the illustrated embodiment, the primary lock 111 is an elastic arm formed on the top plate 116. The lock 111 extends obliquely from the front end of the top plate 116 towards the back and outward and is used to rest against a limit step 31 inside the housing 3 to prevent terminal 1 from being pulled out of the housing 3, as shown in FIG. 6.

As shown in FIGS. 1 and 2, in the illustrated embodiment, the mating part 11 further includes a guide rib 117, which extends along the longitudinal direction Y of terminal 1 and is perpendicular to the transverse direction X of terminal 1. The guide rib 117 is located on one side of the transverse direction X of the mating part 11 and is used to cooperate with a guide slot 37 in the housing 3 of the connector, shown in FIG. 7, to guide the terminal 1 to be inserted into the housing 3 in the correct orientation. This can prevent terminal 1 from being inserted into the housing 3 in the wrong orientation.

As shown in FIGS. 1, 2, and 6, in the illustrated embodiment, the secondary lock feature 112 is a blocking step formed at the rear end of the mating part 11, suitable for resting against the secondary lock 4.

As shown in FIG. 1, in the illustrated embodiment, the terminal 1 further includes a crimping part 12 for crimping onto a cable 2. The mating part 11 and the crimping part 12 are respectively located at the longitudinal ends of terminal 1 and are connected to each other.

As shown in FIG. 1, in the illustrated embodiment, the crimping part 12 includes a first crimping part 12a and a second crimping part 12b. The first crimping part 12a is used to crimp onto a conductor core 22 of the cable 2, for electrical connection with the cable 2. The second crimping part 12b is used to crimp onto an outer layer 21 of the cable 2.

In the illustrated embodiment, the terminal 1 is an integral stamped part. This can reduce manufacturing costs.

As shown in FIGS. 1 to 7, in another exemplary embodiment of the present invention, an electrical connection module is also disclosed. The electrical connection module includes a terminal 1 and a cable 2. One end of the cable 2 is electrically connected to the terminal 1, as shown in FIG. 1.

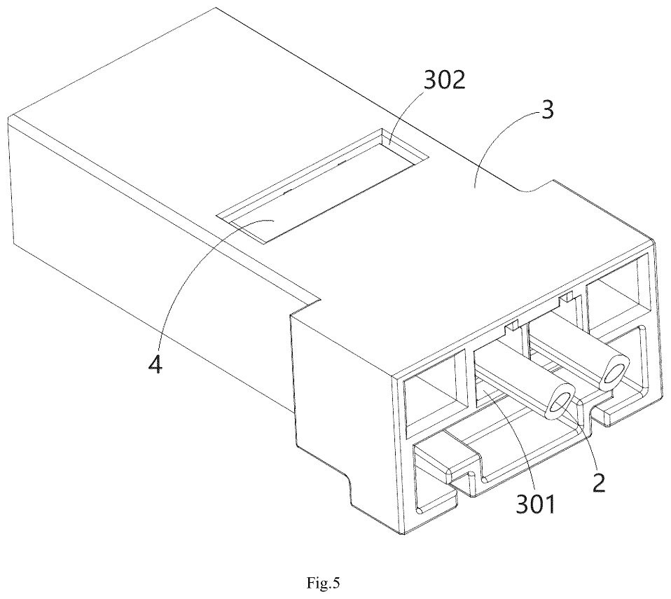

As shown in FIGS. 1 to 7, in another exemplary embodiment of the present invention, a connector is also disclosed. The connector includes: a housing 3, a secondary lock 4, and the aforementioned terminal 1 or electrical connection module. The housing 3 has a terminal hole 301 extending along its longitudinal direction Y and a secondary lock slot 302 extending along its transverse direction X and communicated with the terminal hole 301, as shown in FIGS. 5-7. The terminal 1 or electrical connection module is inserted into the terminal hole 301. The secondary lock 4 is inserted into the secondary lock slot 302 and engages with the secondary lock feature 112 on terminal 1 to lock the terminal 1 in the terminal hole 301.

As shown in FIG. 6, in the illustrated embodiment, a limit step 31 perpendicular to the longitudinal direction Y is formed inside the housing 3. The limit step 31 is adapted to rest against the rear end of the primary lock 111 of the terminal 1 to lock the terminal 1 in the terminal hole 201.

As shown in FIG. 6, in the illustrated embodiment, the secondary lock feature 112 of terminal 1 is a blocking step perpendicular to the longitudinal direction Y of the housing 3, and the secondary lock 4 is adapted to rest against the blocking step to lock the terminal 1 in the terminal hole 201.

As shown in FIG. 7, in the illustrated embodiment, a guide slot 37 extending along the longitudinal direction Y is formed in the housing 3. The guide slot 37 is used to cooperate with the guide rib 117 on the terminal 1 to guide the terminal 1 to be inserted into the housing 3 in the correct orientation.

As shown in FIG. 7, in the illustrated embodiment, multiple terminal insertion holes 301 are formed in the housing 3, and the secondary lock slot 302 is communicated with the multiple terminal insertion holes 301. The connector includes multiple terminals 1, which are respectively inserted into multiple terminal holes 301. The secondary lock 4 is simultaneously engaged with the secondary lock features 112 of multiple terminals 1 to lock multiple terminals 1 in the housing 3 at the same time.

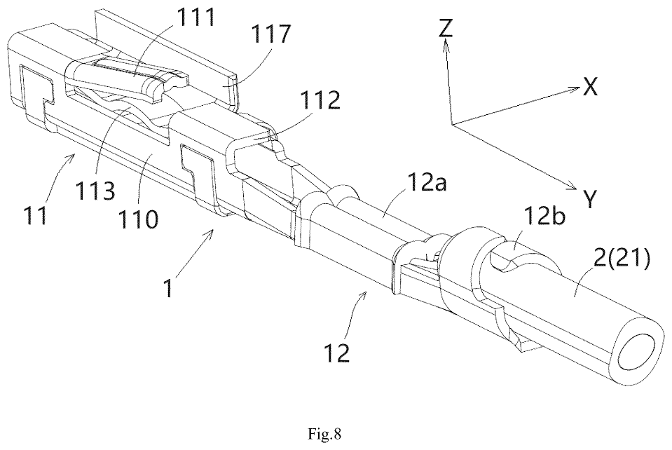

FIGS. 8 to 10 show a second embodiment according to the present invention. The main difference between the second embodiment shown in FIGS. 8 to 10 and the first embodiment shown in FIGS. 1 to 7 is the addition of a second cantilever 114. The other technical features of the second embodiment are basically the same as those of the first embodiment and can refer to the first embodiment shown in FIGS. 1 to 7.

As shown in FIGS. 8 to 10, in an exemplary embodiment of the present invention, a terminal 1 of a connector is disclosed. The terminal 1 includes a mating part 11 for mating with a mating terminal 1′ of a mating connector. The mating part 11 has an insertion cavity 101 extending along the longitudinal direction Y of terminal 1 and a first cantilever 113 located in the insertion cavity 101. The first cantilever 113 has multiple first electrical contacts 113a, which are spaced apart from each other in the longitudinal direction Y for simultaneous electrical contact with one side of the mating terminal 1′ inserted into the insertion cavity 101. The free end 113c of the first cantilever 113 is pressed against the inner wall surface of the insertion cavity 101. This ensures stable and reliable electrical contact between the first cantilever 113 and the mating terminal 1′.

As shown in FIGS. 8 to 10, in the illustrated embodiment, the mating part 11 also has a primary lock 111 adapted to engage with the housing 3 of the connector and a secondary lock feature 112 adapted to engage with the secondary lock 4 inserted into the housing 3, so as to be able to lock the terminal 1 in the housing 3 by the primary lock 111 and the secondary lock 4.

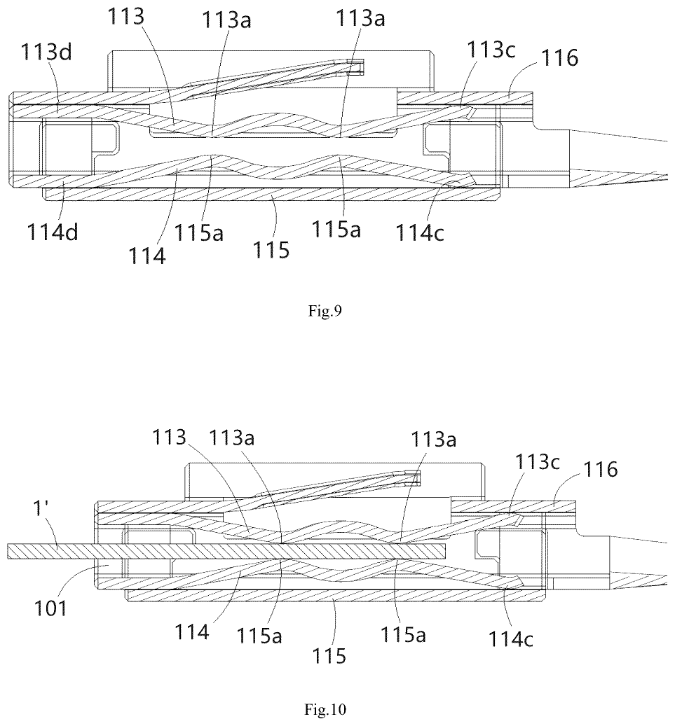

As shown in FIGS. 9 and 10, in the illustrated embodiment, the mating part 11 includes a bottom plate 115 and a top plate 116 that are opposite in the height direction Z of terminal 1, and a pair of side plates 110 that are opposite in the transverse direction X of terminal 1. The aforementioned insertion cavity 101 is surrounded by the top plate 116, the bottom plate 115, and the pair of side plates 110.

As shown in FIGS. 8 to 10, in the illustrated embodiment, the mating part 11 has front and rear ends that are opposite in the longitudinal direction Y, and the first cantilever 113 extends between the front and rear ends of the mating part 11. The fixed end 113d of the first cantilever 113 is connected to the front end of the top plate 116, and the free end 113c of the first cantilever 113 is pressed against the inner side of the rear end of the top plate 116.

As shown in FIGS. 8 to 10, in the illustrated embodiment, the mating part 11 also includes a second cantilever 114. The second cantilever 114 is located in the insertion cavity 101 and is opposite to the first cantilever 13 in the height direction Z. The second cantilever 114 has multiple second electrical contacts 115a, which are spaced apart from each other in the longitudinal direction Y for simultaneous electrical contact with the other side of the mating terminal 1′ inserted into the aforementioned insertion cavity 101.

As shown in FIGS. 8 to 10, in the illustrated embodiment, the second cantilever 114 extends between the front and rear ends of the mating part 11, with the fixed end 114d of the second cantilever 114 connected to the front end of the bottom plate 115, and the free end 114c of the second cantilever 114 resting on the inner side of the rear end of the bottom plate 115.

As shown in FIGS. 8 to 10, in the illustrated embodiment, the multiple second electrical contacts 115a correspond to the multiple first electrical contacts 113a and are aligned to multiple first electrical contacts 113a in the height direction Z, respectively.

As shown in FIGS. 8 to 10, in the illustrated embodiment, the primary lock 111 is an elastic arm formed on the top plate 116. The primary lock 111 extends obliquely from the front end of the top plate 116 towards the back and outward and is used to rest against a limit step 31 inside the housing 3 to prevent terminal 1 from being pulled out of the housing 3.

As shown in FIGS. 8 to 10, in the illustrated embodiment, the mating part 11 further includes a guide rib 117 that extends along the longitudinal direction Y of terminal 1 and is perpendicular to the transverse direction X of terminal 1. The guide rib 117 is located on one side of the transverse direction X of the mating part 11 and is used to cooperate with a guide slot 37 in the housing 3 of the connector to guide the terminal 1 to be inserted into the housing 3 in the correct orientation. This can prevent the terminal 1 from being inserted into the housing 3 in the wrong orientation.

As shown in FIGS. 8 to 10, in the illustrated embodiment, the secondary lock feature 112 is a blocking step formed at the rear end of the mating part 11, suitable for resting against the secondary lock 4.

As shown in FIGS. 8 to 10, in the illustrated embodiment, the terminal 1 further includes a crimping part 12 for crimping onto a cable 2. The mating part 11 and the crimping part 12 are respectively located at the longitudinal ends of terminal 1 and are connected to each other.

As shown in FIGS. 8 to 10, in the illustrated embodiment, the crimping part 12 includes a first crimping part 12a and a second crimping part 12b. The first crimping part 12a is used to crimp onto a conductor core 22 of the cable 2, for electrical connection with the cable 2. The second crimping part 12b is used to crimp onto an outer layer 21 of a cable 2.

In the illustrated embodiment of FIGS. 8 to 10, the terminal 1 is an integral stamped part. This can reduce manufacturing costs.

As shown in FIGS. 8 to 10, in another exemplary embodiment of the present invention, an electrical connection module is also disclosed. The electrical connection module mainly includes a terminal 1 and a cable 2, with one end of the cable 2 electrically connected to the terminal 1.

As shown in FIGS. 8 to 10, in another exemplary embodiment of the present invention, a connector is also disclosed. The connector mainly includes: a housing 3, a secondary lock 4, and the aforementioned terminal 1 or electrical connection module. The housing 3 has a terminal hole 301 extending along the longitudinal direction Y and a secondary lock slot 302 extending along the transverse direction X and communicate with the terminal hole 201. The terminal 1 or electrical connection module is inserted into the terminal hole 301. The secondary lock 4 is inserted into the secondary lock slot 302 and engages with the secondary lock feature 112 on the terminal 1 to lock terminal 1 in the terminal hole 201.

In the embodiment, a limit step 31 perpendicular to the longitudinal direction Y is formed inside the housing 3. The limit step 31 is adapted to rest against the rear end of the primary lock 111 of the terminal 1 to lock the terminal 1 in the terminal hole 201.

As shown in FIGS. 8 to 10, in the illustrated embodiment, the secondary lock feature 112 of terminal 1 is a blocking step perpendicular to the longitudinal direction Y of the housing 3, and the secondary lock 4 is adapted to rest against the blocking step to lock the terminal 1 in the terminal hole 201.

In the embodiment, a guide slot 37 extending along the longitudinal direction Y is formed in the housing 3. The guide slot 37 is used to cooperate with the guide rib 117 on the terminal 1 to guide the terminal 1 to be inserted into the housing 3 in the correct orientation.

In the embodiment, multiple terminal insertion holes 301 are formed in the housing 3, and the secondary lock slot 302 is communicated with the multiple terminal insertion holes 301. The connector includes multiple terminals 1, which are respectively inserted into multiple terminal holes 301. The secondary lock 4 is simultaneously engaged with the secondary lock features 112 of multiple terminals 1 to lock multiple terminals 1 in the housing 3 at the same time.

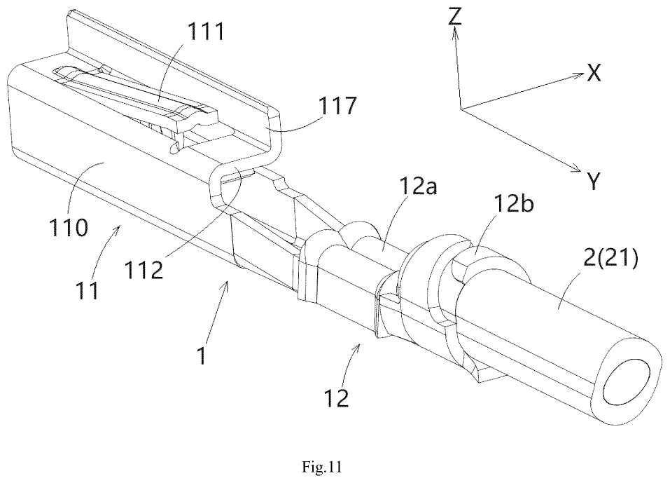

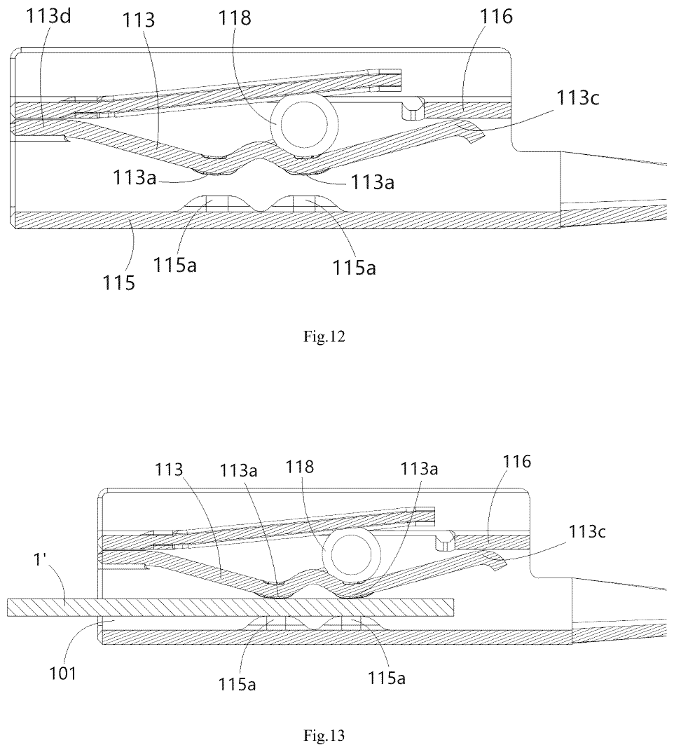

FIGS. 11 to 13 show a third embodiment according to the present invention. The main difference between the third embodiment shown in FIGS. 11 to 13 and the first embodiment shown in FIGS. 1 to 7 is the addition of a support ring 118. The other technical features of the third embodiment are basically the same as those of the first embodiment and can be referred to in the first embodiment shown in FIGS. 1 to 7.

As shown in FIGS. 11 to 13, in an exemplary embodiment of the present invention, a terminal 1 of a connector is disclosed. The terminal 1 includes a mating part 11 for mating with a mating terminal 1′ of a mating connector. The mating part 11 has an insertion cavity 101 extending along the longitudinal direction Y of terminal 1 and a first cantilever 113 located in the insertion cavity 101. The first cantilever 113 has multiple first electrical contacts 113a, which are spaced apart from each other in the longitudinal direction Y for simultaneous electrical contact with one side of the mating terminal 1′ inserted into the insertion cavity 101. The free end 113c of the first cantilever 113 is pressed against the inner wall surface of the insertion cavity 101. This ensures stable and reliable electrical contact between the first cantilever 113 and the mating terminal 1′.

As shown in FIGS. 11 to 13, in the illustrated embodiment, the mating part 11 also has a primary lock 111 adapted to engage with the housing 3 of the connector and a secondary lock feature 112 adapted to engage with a secondary lock 4 inserted into the housing 3, so as to be able to lock the terminal 1 in the housing 3 by the primary lock 111 and the secondary lock 4.

As shown in FIGS. 11 to 13, in the illustrated embodiment, the mating part 11 includes a bottom plate 115 and a top plate 116 that are opposite in the height direction Z of terminal 1, and a pair of side plates 110 that are opposite in the transverse direction X of terminal 1. The aforementioned insertion cavity 101 is surrounded by the top plate 116, the bottom plate 115, and the pair of side plates 110.

As shown in FIGS. 11 to 13, in the illustrated embodiment, the mating part 11 has front and rear ends that are opposite in the longitudinal direction Y, and the first cantilever 113 extends between the front and rear ends of the mating part 11. The fixed end 113d of the first cantilever 113 is connected to the front end of the top plate 116, and the free end 113c of the first cantilever 113 is pressed against the inner side of the rear end of the top plate 116.

As shown in FIGS. 11 to 13, in the illustrated embodiment, multiple second electrical contacts 115a are formed on the inner side of the bottom plate 115, which are used to simultaneously make electrical contact with the other side of the mating terminal 1′ inserted into the aforementioned insertion cavity 101.

As shown in FIGS. 11 to 13, in the illustrated embodiment, the multiple second electrical contacts 115a correspond to the multiple first electrical contacts 113a and are aligned to multiple first electrical contacts 113a in the height direction Z, respectively.

As shown in FIGS. 11 to 13, in the illustrated embodiment, the primary lock 111 is an elastic arm formed on the top plate 116. The lock 111 extends obliquely from the front end of the top plate 116 towards the back and outward and is used to rest against a limit step 31 inside the housing 3 to prevent terminal 1 from being pulled out of the housing 3.

As shown in FIGS. 11 to 13, in the illustrated embodiment, the terminal 1 further includes a support ring 118, which is clamped between the primary lock 111 and the first cantilever 113 for supporting the first cantilever 113. The support ring 118 is opposite to the first electrical contact 113c closest to the free end 113c of the first cantilever 113 among the multiple first electrical contacts 113a.

As shown in FIGS. 11 to 13, in the illustrated embodiment, the mating part 11 further includes a guide rib 117 that extends along the longitudinal direction Y of terminal 1 and is perpendicular to the transverse direction X of terminal 1. The guide rib 117 is located on one side of the transverse direction X of the mating part 11 and is used to cooperate with a guide slot 37 in the housing 3 of the connector to guide the terminal 1 to be inserted into the housing 3 in the correct orientation. This can prevent terminal 1 from being inserted into housing 3 in the wrong orientation.

As shown in FIGS. 11 to 13, in the illustrated embodiment, the secondary lock feature 112 is a blocking step formed at the rear end of the mating part 11, suitable for resting against the secondary lock 4.

As shown in FIGS. 11 to 13, in the illustrated embodiment, the terminal 1 further includes a crimping part 12 for crimping onto a cable 2. The mating part 11 and the crimping part 12 are respectively located at the longitudinal ends of the terminal 1 and are connected to each other.

As shown in FIG. 11, in the illustrated embodiment, the crimping part 12 includes a first crimping part 12a and a second crimping part 12b. The first crimping part 12a is used to crimp onto a conductor core 22 of the cable 2, for electrical connection with the cable 2. The second crimping part 12b is used to crimp onto an outer layer 21 of the cable 2.

As shown in FIG. 11, in another exemplary embodiment of the present invention, an electrical connection module is also disclosed. The electrical connection module includes a terminal 1 and a cable 2, with one end of the cable 2 electrically connected to the terminal 1.

In another exemplary embodiment of the present invention, a connector is also disclosed. The connector includes: a housing 3, a secondary lock 4, and the aforementioned terminal 1 or electrical connection module. The housing 3 has a terminal hole 301 extending along the longitudinal direction Y and a secondary lock slot 302 extending along the transverse direction X and communicated with the terminal hole 201. The terminal 1 or electrical connection module is inserted into the terminal hole 301. The secondary lock 4 is inserted into the secondary lock slot 302 and engages with the secondary lock feature 112 on the terminal 1 to lock the terminal 1 in the terminal hole 201.

In the embodiment, a limit step 31 perpendicular to the longitudinal direction Y is formed inside the housing 3. The limit step 31 is adapted to rest against the rear end of the primary lock 111 of the terminal 1 to lock the terminal 1 in the terminal hole 201.

As shown in FIGS. 11 to 13, in the illustrated embodiment, the secondary lock feature 112 of terminal 1 is a blocking step perpendicular to the longitudinal direction Y of the housing 3, and the secondary lock 4 is adapted to rest against the blocking step to lock the terminal 1 in the terminal hole 201.

In the embodiment, a guide slot 37 extending along the longitudinal direction Y is formed on the housing 3. The guide slot 37 is used to cooperate with the guide rib 117 on the terminal 1 to guide the terminal 1 to be inserted into the housing 3 in the correct orientation.

In the embodiment, multiple terminal insertion holes 301 are formed in the housing 3, and the secondary lock slot 302 is communicated with the multiple terminal insertion holes 301. The connector includes multiple terminals 1, which are respectively inserted into multiple terminal holes 301. The secondary lock 4 is simultaneously engaged with the secondary lock features 112 of multiple terminals 1 to lock multiple terminals 1 in the housing 3 at the same time.

In the aforementioned exemplary embodiments according to the present invention, the terminal of the connector has multiple electrical contacts, ensuring reliable and stable electrical contact with the terminal of the mating connector.

In addition, in the aforementioned exemplary embodiments according to the present invention, the terminal of the connector also has a primary lock, a secondary locking feature and an anti-mis-operation guide rib, reducing the manufacturing cost of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a mating part having an insertion cavity extending along a longitudinal direction of the terminal and a first cantilever located in the insertion cavity, the first cantilever has a plurality of first electrical contacts spaced apart from each other in the longitudinal direction and simultaneously electrically contacting a side of a mating terminal inserted into the insertion cavity, a free end of the first cantilever is pressed against an inner wall surface of the insertion cavity, the mating part has a primary lock engaging a housing of a connector and a secondary lock feature engaging a secondary lock inserted into the housing, locking the terminal in the housing through the primary lock and the secondary lock.

2. The terminal according to claim 1, wherein the mating part has a bottom plate and a top plate opposite the bottom plate in a height direction of the terminal, the mating part has a pair of side plates opposite each other in a transverse direction of the terminal, the insertion cavity is surrounded by the top plate, the bottom plate, and the pair of side plates.

3. The terminal according to claim 2, wherein the mating part has a front end and a rear end opposite each other in the longitudinal direction, the first cantilever extends between the front end and the rear end of the mating part, a fixed end of the first cantilever is connected to the front end of the top plate, the free end of the first cantilever is pressed against an inner side of a rear end of the top plate.

4. The terminal according to claim 3, wherein a plurality of second electrical contacts are formed on an inner side of the bottom plate, the second electrical contacts simultaneously electrically contact another side of the mating terminal inserted into the insertion cavity.

5. The terminal according to claim 2, wherein the first cantilever has a support portion protruding toward the top plate, the support portion is located between a pair of adjacent first electrical contacts in the longitudinal direction, and when the mating terminal is inserted into the insertion cavity of the mating part, the support portion and free end of the first cantilever simultaneously rest on an inner side of the top plate.

6. The terminal according to claim 3, wherein the mating part has a second cantilever in the insertion cavity and opposite to the first cantilever in the height direction, the second cantilever has a plurality of second electrical contacts spaced apart from each other in the longitudinal direction and simultaneously electrically contact another side of the mating terminal inserted into the insertion cavity.

7. The terminal according to claim 6, wherein the second cantilever extends between the front end and the rear end of the mating part, a fixed end of the second cantilever is connected to a front end of the bottom plate, a free end of the second cantilever rests on an inner side of a rear end of the bottom plate.

8. The terminal according to claim 3, wherein the primary lock is an elastic arm formed on the top plate, the primary lock extends obliquely from the front end of the top plate towards the rear end and outward, the primary lock rests on a limit step inside the housing to prevent the terminal from being pulled out of the housing.

9. The terminal according to claim 8, further comprising a support ring clamped between the primary lock and the first cantilever to support the first cantilever, the support ring is opposite to one of the first electrical contacts closest to the free end of the first cantilever among the plurality of first electrical contacts.

10. The terminal according to claim 9, wherein a plurality of second electrical contacts are formed on an inner side of the bottom plate, the second electrical contacts simultaneously electrically contact another side of the mating terminal inserted into the insertion cavity.

11. The terminal according to claim 1, wherein the mating part includes a guide rib extending along the longitudinal direction of the terminal and perpendicular to a transverse direction of the terminal, the guide rib is located on a side of the transverse direction of the mating part, and cooperates with a guide slot in the housing of the connector to guide the terminal to be inserted into the housing in a correct orientation.

12. The terminal according to claim 1, further comprising a crimping part crimping onto a cable, the mating part and the crimping part are respectively located at a pair of longitudinal ends of the terminal and are connected to each other.

13. The terminal according to claim 12, wherein the crimping part includes a first crimping part crimping onto a conductor core of the cable and a second crimping part crimping onto an outer layer of the cable.

14. The terminal according to claim 13, wherein the terminal is an integral stamped piece.

15. An electrical connection module, comprising:
a terminal including a mating part having an insertion cavity extending along a longitudinal direction of the terminal and a first cantilever located in the insertion cavity, the first cantilever has a plurality of first electrical contacts spaced apart from each other in the longitudinal direction and simultaneously electrically contacting a side of a mating terminal inserted into the insertion cavity, a free end of the first cantilever is pressed against an inner wall surface of the insertion cavity, the mating part has a primary lock engaging a housing of a connector and a secondary lock feature engaging a secondary lock inserted into the housing, locking the terminal in the housing through the primary lock and the secondary lock; and
a cable having an end electrically connected to the terminal.

16. A connector, comprising:
a housing having a terminal hole extending along a longitudinal direction and a secondary lock slot extending along a transverse direction and communicated with the terminal hole;
a terminal inserted into the terminal hole, the terminal including a mating part having an insertion cavity extending along the longitudinal direction and a first cantilever located in the insertion cavity, the first cantilever has a plurality of first electrical contacts spaced apart from each other in the longitudinal direction and simultaneously electrically contacting a side of a mating terminal inserted into the insertion cavity, a free end of the first cantilever is pressed against an inner wall surface of the insertion cavity, the mating part has a primary lock engaging the housing and a secondary lock feature; and
a secondary lock inserted into the secondary lock slot and engaging the secondary lock feature to lock the terminal in the terminal hole.

17. The connector according to claim 16, wherein a limit step perpendicular to the longitudinal direction is formed inside the housing, the limit step rests against a rear end of the primary lock of the terminal to lock the terminal in the terminal hole.

18. The connector according to claim 16, wherein the secondary lock feature of the terminal is a blocking step perpendicular to the longitudinal direction of the housing, the secondary lock is rests against the blocking step to lock the terminal in the terminal hole.

19. The connector according to claim 16, wherein a guide slot extending along the longitudinal direction is formed in the housing, the guide slot cooperates with a guide rib on the terminal to guide the terminal to be inserted into the housing in a correct orientation.

20. The connector according to claim 16, wherein the terminal hole is one of a plurality of terminal holes of the housing, the secondary lock slot communicates with the terminal holes, the terminal is one of a plurality of terminals each respectively inserted into one of the plurality of terminal holes, the secondary lock is simultaneously engaged with the secondary lock features of the plurality of terminals to simultaneously lock the terminals in the housing.
